(19) United States
(12) Patent Application Publication
(10) Pub. No.: US 2015/0291411 A1
(43) Pub. Date: Oct. 15, 2015

(54) DEVICE FOR A PRODUCTION AND/OR FOR A DISPENSING

(71) Applicant: Stephanie Ittstein, (US)

(72) Inventor: Stephanie Ittstein, Salenstein (CH)

(21) Appl. No.: 14/681,486

(22) Filed: Apr. 8, 2015

(30) Foreign Application Priority Data
Apr. 9, 2014 (DE) 10 2014 105 058.4

(51) Int. Cl. B67D 7/08

(52) U.S. Cl. CPC B67D 7/08

(57) ABSTRACT

A device for a production of at least one individually adapted dispensing unit and/or auxiliary operative substance unit and/or for a dispensing of at least one individually adapted dispensing unit in dependence on at least one individual parameter is proposed.

### STATE OF THE ART

The invention relates to a device for a production of at least one dispensing unit and/or auxiliary operative substance unit and/or for a dispensing of at least one dispensing unit.

The invention furthermore relates to a method for an operation of the device.

In many fields of everyday life dispensing units and/or auxiliary operative substance units are produced and/or dispensed in a non-individually determined formulation and/or dosage. As a result of this, an underdosage or overdosage of dispensing units and/or auxiliary operative substance units may occur. This can result in an unsatisfactory usage profile of the dispensing units and/or auxiliary operative substance units, which may cause risks.

The objective of the invention is herein, in particular, to make a device available that renders possible a dispensing of at least one dispensing unit having a composition which is adapted to individual requirements, and/or that allows a production of at least one dispensing unit and/or auxiliary operative substance unit having a composition which is adapted to individual requirements. The objective is achieved according to the invention by the features of patent claim 1, while advantageous implementations and further developments of the invention may be gathered from the subclaims.

### Advantages of the Invention

A device for a production of at least one individually adapted dispensing unit and/or auxiliary operative substance unit, and/or for a dispensing of at least one individually adapted dispensing unit in dependence on at least one individual parameter is proposed.

Herein the term “individually adapted” is intended to define in particular a composition of the dispensing unit and/or auxiliary operative substance unit, which is specifically tuned to an individual and/or an application. The dispensing unit and/or auxiliary operative substance unit produced by means of the device according to the invention thus has preferably a composition in which a status of an individual and/or a type of an application can be taken into account in a production and/or in a dispensing.

Here the term “dispensing unit and/or auxiliary operative substance unit” is to define in particular a unit which can be dispensed by an individual, is applicable on a skin of an individual or an animal or is embodied as a work material (operative substance or auxiliary substance). The dispensing unit and/or auxiliary operative substance unit that can be produced by means of the device is implementable such that it is liquid, gaseous or solid. The dispensing unit and/or auxiliary operative substance unit is thus implementable as a tablet, as a liquid, as a paste, as a cream, as a powder or the like. The dispensing unit and/or auxiliary operative substance unit may thus be implemented as a tablet, as a drink, as a cream, as a paste, as a liquid, as a gas or the like. The dispensing unit and/or auxiliary operative substance unit can herein be embodied as a victual, as a nutritional supplement, as a medication, as cosmetics, as luxury food, as food for animals, as a lubricant or the like.

An “individual parameter” is here to be understood, in particular, as a parameter describing and/or defining a status of an individual and/or a type of a usage. Especially preferably the individual parameter is implemented for a production and/or for a dispensing of the dispensing unit and/or auxiliary operative substance unit as a vital parameter of an individual, as a health status parameter of an individual, as a performance parameter of an individual, as an application parameter or the like. Thus the at least one individual parameter is embodied, for example, as a pulse, as a blood pressure, as a heart rhythm, as a blood count, as a tooth status parameter, as a skin-friendliness parameter, as a stress-ECG parameter, as a lubricant viscosity, as a component glue type connection parameter or the like.

The device is implementable as an end user device, as an industrial device, as a craftsman's device or the like. Especially preferably the device is implemented as an end user device. Thus the device can preferably be acquired and/or used by an end user. The device is especially preferably provided for a production of at least one individually adapted dispensing unit and/or auxiliary operative substance unit in dependence of the at least one individual parameter and for a dispensing of at least one individually adapted dispensing unit in dependence of the at least one individual parameter. By “provided” is to be understood, in particular, specifically designed and/or specifically equipped. By an element and/or a unit being provided for a certain function is to be understood, in particular, that the element and/or the unit implement/implements and/or carry out/carries out this certain function in at least one application state and/or operating state. The device is herein in particular provided to mix components of the dispensing unit and/or auxiliary operative substance unit with each other in dependence on the at least one individual parameter. An individual concentration of respective components of the dispensing unit and/or auxiliary operative substance unit is thus producible depending on the at least one individual parameter. A production of the individually adapted dispensing unit and/or auxiliary operative substance unit is herein effected following an individually generated formula, which depends on the at least one individual parameter. The device according to the invention is advantageously useful for an emergency medication, for a production of individually adapted baby food, for a production of an individually adapted cream, for a production of an individually adapted vaccine, for a production of individually adapted victuals or the like.

Moreover the device is provided, in addition to a production of the dispensing unit and/or auxiliary operative substance unit, to at least partially automatically dispense, in particular to a human being or an animal, a quantity of the dispensing unit and/or auxiliary operative substance unit produced by means of the device in dependence on the at least one individual parameter. In an alternative embodiment the device is provided merely for a production of the individually adapted dispensing unit and/or auxiliary operative substance unit in dependence on at least one individual parameter. In a further alternative embodiment the device is in particular provided merely for a dispensing of at least one individually adapted dispensing unit in dependence on at least one individual parameter.

By means of the device according to the invention a dispensing unit and/or auxiliary operative substance unit which is adapted to special requirements can advantageously be produced and/or dispensed. Thus an under-dosage or over-dosage of the dispensing unit and/or auxiliary operative substance unit is advantageously avoidable. An advantageous usage profile of the dispensing unit and/or auxiliary operative substance unit can thus be rendered possible.

Advantageously the device comprises at least one formulation and/or dosage generating unit, which is provided to generate a formulation and/or a dosage in dependence on the at least one individual parameter. The formulation and/or dosage generating unit is preferably provided to generate a formulation for the production of the dispensing unit and/or auxiliary operative substance unit in dependence on the at least one individual parameter and/or to effect a dosage of the dispensing unit and/or auxiliary operative substance unit in dependence on the at least one individual parameter. Thus advantageously a formulation can be generated and/or a dosage can be effected, which is specifically adapted to a status of an individual and/or to an application type of the dispensing unit and/or auxiliary operative substance unit.

It is further proposed that the formulation and/or dosage generating unit comprises at least one control and/or regulation unit having at least one operation program, which creates a formulation profile and/or dosage profile in dependence of an input of the at least one individual parameter. By a “control and/or regulation unit” is to be understood, in particular, a unit having at least one control electronics. A “control electronics” is to be understood, in particular, as a unit with a processor unit and with a storage unit as well as with an operation program that is stored in the storage unit. The formulation and/or dosage profile is in particular designed in such a way that, upon an input of at least one further individual parameter at a later time, already entered data of the formulation and/or dosage profile are considered and these are taken into account in generating a formulation and/or a dosage. The operation program of the control and/or regulation unit is herein preferably implemented as an analyzis operation program. Herein the operation program preferably comprises a partial query program, which in a targeted manner queries individual parameters and/or data required for generating an individually tuned formulation and/or dosage. The implementation according to the invention advantageously allows an easy operability, as a re-entering of all required data in case of a change of a single parameter is avoidable. Due to regular input of individual parameters, the formulation and/or dosage profile is advantageously adaptable to new conditions. It is herein conceivable that as a result of an input and/or of an automated capturing of the at least one individual parameter, e.g. age, height, weight, nutritional and/or movement behavior or the like, an interactive check-up is carried out by the operation program and a required quantity of nutritional material of the dispensing unit that is to be produced can be calculated. Moreover, input, e.g. actually consumed food and beverages as well as actually executed activities (sports and/or everyday movement), can be taken into account for generating a formulation and/or dosage. An accurate adjustment of the formulation and/or dosage may thus be rendered possible.

Furthermore it is proposed that the device comprises at least one supplies unit for a stockage of at least one component for the production of the individually adapted dispensing unit and/or auxiliary operative substance unit. To this purpose the supplies unit preferably comprises at least one stock container, in which the at least one component for the production of the individually adapted dispensing unit and/or auxiliary operative substance unit is arrangeable. The stock container can herein be embodied as a fluid stock container and/or as a solid-matter stock container. Especially preferably the supplies unit is implemented to be replenishable. It is however also conceivable that the supplies unit is implemented as a single-use supplies unit, which is exchanged for a further supplies unit after use. Herein it is conceivable that the supplies unit is implemented as a supplies-exchange cartridge unit. Moreover it is conceivable that, as an alternative or in addition to the supplies unit, the device comprises a direct-processing unit, which is provided for directly processing raw materials for a production of the dispensing unit and/or auxiliary operative substance unit, in particular for milling, for grinding, for melting, for turning, for injection-molding or the like, and for feeding these, for example, to a production process of the dispensing unit and/or auxiliary operative substance unit by means of a conveying unit. By means of the implementation according to the invention, a component for the production of the individually adapted dispensing unit and/or auxiliary operative substance unit can be stocked in a constructively simple manner, such that a production of the dispensing unit and/or auxiliary operative substance unit can be effected at least substantially independently from a location. Thus a high flexibility of the device is achievable.

Furthermore it is proposed that the supplies unit comprises at least two separate chambers for a stockage of at least two different components of the individually adapted dispensing unit and/or auxiliary operative substance unit. Especially preferably the supplies unit comprises a number of chambers, not equal to two, for a stockage of different components of the individually adapted dispensing unit and/or auxiliary operative substance unit. The two separate chambers are herein arrangeable in a shared stock container of the supplies unit. It is however also conceivable that the supplies unit comprises at least two separately embodied stock containers for an implementation of the two separate chambers. The stock containers can in particular be arranged at a housing unit and/or at a receiving unit of the device such that they are exchangeable. Thus advantageously a huge variety of potential compositions of the dispensing unit and/or auxiliary operative substance unit can be rendered possible. Moreover an uncomplicated exchange of different stock containers with different components of the individually adapted dispensing unit and/or auxiliary operative substance unit can be rendered possible.

It is also proposed that the device comprises at least one dosage unit for a dosage of at least one component of the individually adapted dispensing unit and/or auxiliary operative substance unit and/or for an output dosage of the individually adapted dispensing unit and/or auxiliary operative substance unit. Especially preferably the dosage unit comprises at least one dosage nozzle. The dosage nozzle is preferentially provided to output a quantity of the component of the individually adapted dispensing unit and/or auxiliary operative substance unit in dependence of a formulation generated by means of the formulation and/or dosage generating unit. It is however also conceivable that the dosage nozzle is provided, additionally or as an alternative, to output a quantity of the individually adapted dispensing unit and/or auxiliary operative substance unit. Particularly preferably the dosage unit comprises an output dosage element, e.g. an output dosage nozzle, which is provided to output a quantity of the individually adapted dispensing unit and/or auxiliary operative substance unit in dependence of the at least one individual parameter. By the implementation of the device according to the invention, advantageously a precise dosage of at least one component of the individually adapted dispensing unit and/or auxiliary operative substance unit and/or a precise output dosage of the individually adapted dispensing unit and/or auxiliary operative substance unit can be effected, which is particularly advantageously adapted to an individual requirement and/or to an individual application.

Furthermore it is proposed that the device comprises at least one mixing unit for mixing components of the individually adapted dispensing unit and/or auxiliary operative substance unit. Preferably the mixing unit is provided to produce from starting materials, in particular from components of the dispensing unit and/or auxiliary operative substance unit, a mixture that forms the dispensing unit and/or auxiliary operative substance unit. The mixture produced by means of the mixing unit can herein be implemented in gaseous, liquid or solid form. The mixing unit is implementable as a compulsory mixing unit, as a gravity mixing unit, as a stirring mixing unit, as a kneading mixing unit, as a flow mixing unit, as a proportioning-pump mixing unit or as another mixing unit that is deemed expedient by a person skilled in the art. The dosage unit controls and/or regulates, preferably in dependence of a formulation and/or dosage generated by means of the formulation and/or dosage generating unit, what quantity of a certain component of the individually adapted dispensing unit and/or auxiliary operative substance unit gets into the mixing unit. The implementation of the device according to the invention allows an advantageous mixing of components of the individually adapted dispensing unit and/or auxiliary operative substance unit.

Further it is proposed that the device comprises at least one input unit for a manual input of at least one individually tuned formulation and/or dosage for the production of the individually adapted dispensing unit and/or auxiliary operative substance unit. The input unit is herein implementable as an acoustical, as a haptic and/or as an optical input unit. In case of an implementation of the input unit as a purely acoustical input unit, the individually tuned formulation and/or dosage can be entered by means of an acoustical signal, e.g. by means of a voice control or the like. In case of an implementation of the input unit as a purely haptic input unit, the individually tuned formulation and/or dosage can be entered by means of a haptic signal, e.g. by means of a keyboard, by means of a selector switch, by means of a touch-sensitive display or the like. In case of an implementation of the input unit as a purely optical input unit, the individually tuned formulation and/or dosage can be entered by means of an optical signal, e.g. by means of a barcode, by means of a camera or the like. It is however also conceivable that the input unit is implemented as a combination of an acoustical, haptic and/or optical input unit. It is moreover conceivable that the formulation can be entered by means of another method for data transmission that is deemed expedient by a person skilled in the art, e.g. by means of an RFID procedure, by means of an NFC procedure, by means of USB, by means of FireWire or the like. By the implementation of the device according to the invention, a comfortable operation of the device can advantageously be rendered possible. Moreover advantageously, for example, a calibration of a released formulation with a formulation and/or dosage generated by the formulation and/or dosage generating unit can be effected. Thus a high degree of safety against an overdosage or a wrong formulation can advantageously be achieved.

It is further proposed that the device comprises at least one evaluation unit, which is provided to evaluate the at least one individually entered parameter at least in view of generating an individually tuned formulation and/or dosage. Especially preferentially the evaluation unit is provided to compare actual data with set data and to render possible an individually tuned formulation and/or dosage on the basis of the at least one individually entered parameter. Thus a monitoring of an effect of the dispensing unit and/or auxiliary operative substance unit is preferably possible.

Furthermore it is proposed that the device comprises at least one sensor unit, which is provided to identify the at least one individual parameter which can be used for generating an individually tuned formulation and/or dosage. Especially preferably the sensor unit comprises at least one sensor element for a capturing of the at least one individual parameter. The sensor element is herein provided, in particular, to capture at least a vital parameter of an individual, a health status parameter of an individual, a performance parameter of an individual, an application parameter or the like. The sensor element is thus embodied e.g. as a pulse capturing element, as a blood pressure capturing element, as a heart rhythm capturing element, as a blood count capturing element, as a tooth status capturing element, as a skin friendliness capturing element, as a step counting element, as a sleep behavior capturing element, as a biorhythm capturing element, as a blood sugar level capturing element, as an insulin level capturing element, as a nutrient capturing element, as a metabolism capturing element, as a humidity capturing element, as a blood coagulation capturing element, as a lubricant viscosity capturing element, as a component glue type connection capturing element or the like. By the implementation according to the invention, an at least partially automated capturing of an individual parameter can advantageously be effected. Thus a particularly high degree of operative comfort is achievable, as generating a formulation and/or of a dosage is at least largely independent from a manual input of an individual parameter.

It is also proposed that the device comprises at least one communication unit, which is provided to exchange electronic data with at least one external unit. The communication unit is preferably embodied as a wireless communication unit. Herein the communication unit can be embodied as a WLAN communication unit, as a Bluetooth communication unit, as a radio communication unit, as an RFID communication unit, as an NFC unit, as an infrared communication unit, as a mobile network communication unit or the like. Particularly preferably the communication unit is provided for a bi-directional data transmission. In an alternative embodiment the communication unit is embodied as a wired communication unit, e.g. as a LAN communication unit, as a USB communication unit or the like. This advantageously allows an exchange of electronic data with an external unit, e.g. a smartphone. The external unit preferentially comprises an app for a communication with the communication unit, which app is provided to allow an input and/or an automated capturing of the at least one individual parameter. Herein the app can, for example, also take an individual exercise plan into account. It is however also conceivable that the device can exchange electronic data with a unit embodied differently from a smartphone by means of the communication unit, e.g. with a PC, with a laptop computer, with a server or the like. Thus a transmission and/or an exchange of electronic data can advantageously be rendered possible to the purpose of verifying, changing and/or validating a generated formulation and/or dosage, in particular by a person skilled in the art, e.g. a physician, a pharmacist, a product producer, a sports coach or the like. Thus a safe formulation and/or dosage can advantageously be generated. Moreover, advantageously a monitoring of the generated formulation and/or dosage can be rendered possible. Moreover, advantageously a monitoring of a person carrying a device according to the invention on his body is possible. Moreover, due to a capturing of individual parameters of a person carrying a device according to the invention on his body, advantageously a monitoring of vital functions can be effected, wherein in case of identifying an emergency situation, an emergency signal with evaluable data is sent to an emergency unit via the communication unit. Moreover, e.g. following a communication with a smartphone having a formulation and/or dosage app, by means of the formulation and/or dosage app a formulation and/or a dosage of an individually adapted dispensing unit can be generated, which can be transmitted to the device and/or on the basis of which an individually adapted dispensing unit is manually producible.

It is further proposed that the device comprises at least one environment parameter capturing unit, which is provided to capture at least one environment parameter for a generating of an individually tuned formulation and/or dosage. The environment parameter capturing unit comprises at least one environment parameter sensor element, which is provided to capture an environment parameter. The environment parameter sensor element can be embodied as a weather sensor element, as a pollen count sensor element, as an environment temperature sensor element, as an environment air pressure sensor element, as a sunshine duration sensor element, as a precipitation sensor element, as a UV sensor element or the like. It is moreover also conceivable that the formulation and/or dosage generating unit of the device comprises, as an alternative or additionally, a database, in which environment parameters that can be taken into account in generating a formulation and/or a dosage can be lodged. By the implementation of the device according to the invention, advantageously environmental factors can be considered in a generating of a formulation and/or a dosage. Thus, for example, a formulation and/or dosage is advantageously adaptable to a pollen count prediction and/or an actual pollen count.

Furthermore it is proposed that the device comprises at least one formulation output unit, which is provided to output at least one individually tuned formulation and/or dosage. The formulation output unit is herein embodied as an optical and/or acoustical formulation output unit. Preferentially the formulation output unit is embodied as a formulation printer unit. It is however also conceivable that the formulation output unit is, as an alternative or additionally, embodied as a display unit and/or as a loudspeaker unit. Further implementations of the formulation output unit which are deemed expedient by a person skilled in the art are conceivable as well. By the implementation according to the invention, advantageously an output of a formulation and/or of a dosage can be effected to allow a manual mixing of components of the dispensing unit and/or auxiliary operative substance unit.

Further it is proposed that the device comprises at least one packaging generating unit, which is provided to produce a packaging of the individually adapted dispensing unit and/or auxiliary operative substance unit. The packaging generating unit can be additionally provided to produce an outer packaging of the individually adapted dispensing unit and/or auxiliary operative substance unit. Preferably the packaging generating unit is provided to provide the individually adapted dispensing unit and/or auxiliary operative substance unit with a packaging and/or outer packaging following a production. By the implementation of the device according to the invention, following production a secure protection of the individually adapted dispensing unit and/or auxiliary operative substance unit is advantageously achievable. Thus the individually adapted dispensing unit and/or auxiliary operative substance unit can be stocked and/or transported in a comfortable manner.

Furthermore it is proposed that the device comprises at least one injection unit for an injection of at least one individually adapted dispensing unit. The injection unit preferably comprises at least one injection element, in particular an injection needle, for an injection of at least one individually adapted dispensing unit. Herein the device can be implemented in such a way that a respective dosage is can be automatically transmitted or manually entered. Thus, for example, a dispensing of injections, e.g. to a diabetic, or an individual injection when vaccinating, can be carried out. Herein the device is arrangeable at a skin of an individual, e.g. for dispensing the dispensing unit subcutaneously or directly into the bloodstream. By the implementation according to the invention, a direct dispensing of an individually adapted dispensing unit can advantageously be achieved.

Moreover a formulation and/or dosage generating unit of a device according to the invention is proposed. The formulation and/or dosage generating unit is preferably embodied as an independent unit, which is able to exchange electronic data with the device by means of the communication unit. As a result of this, the formulation and/or dosage generating unit is particularly preferentially detachably arrangeable at a holding unit of the device. Thus a high flexibility of the formulation and/or dosage generating unit is advantageously achievable.

Furthermore a method for operating the device according to the invention is proposed, wherein an individual generating of a formulation and/or dosage is effected for a production of at least one individually adapted dispensing unit and/or auxiliary operative substance unit and/or for a dispensing of at least one individually adapted dispensing unit.

By the method according to the invention, advantageously a formulation and/or dosage can be generated, which is adapted to special requirements. Thus an underdosage or overdosage of the dispensing unit and/or auxiliary operative substance unit is advantageously avoidable. Thus an advantageous usage profile of the dispensing unit and/or auxiliary operative substance unit can be rendered possible.

It is also proposed that the generating of a formulation and/or dosage can be carried out by means of a manual input of the at least one individual parameter. Preferably the at least one individual parameter can be entered via the input unit of the device. By the manual input, a formulation and/or dosage can be generated by means of the device, on the basis of which a dispensing unit and/or auxiliary operative substance unit is producible by means of the device in an automated manner, or on the basis of which instructions can be made available to an operator that enable the operator to produce a dispensing unit and/or auxiliary operative substance unit as a result of a mixing, in particular a manual mixing. By the method according to the invention, advantageously an easy input of individual parameters is possible.

Further it is proposed that a capturing of the at least one individual parameter for generating a formulation and/or dosage is effected at least partially in an automated manner. By at least one suitable sensor element individual parameters and further values can be identified and/or analyzed, which are utilizable for a generating of an individually tuned formulation and/or dosage. Thus advantageously a high level of operating comfort can be achieved.

It is moreover proposed that the production of individually adapted dispensing units and/or auxiliary operative substance units and/or the dispensing of individually adapted dispensing units are/is carried out at least in dependence of the at least one individual parameter and at least partially in an automated manner. Herein preferably, following a manual input and/or an automated capturing of the at least one individual parameter, a formulation and/or dosage profile is created and analyzed. Preferably on this basis an individual formulation and/or dosage is generated. Due to recurrent input of individual parameters, the formulation and/or dosage profile are/is adaptable to changing conditions in an automated manner. The input can also be effected, validated and/or adapted by a third person, e.g. a physician/skilled person. Thus an accurate adjustment of the formulation and/or dosage is advantageously achievable.

Furthermore it is proposed that in at least one method step a calibration and/or a verification of the individually tuned formulation and/or dosage is effected. In addition, it is conceivable that external factors or data are considered, e.g. weather, location, temperature, pollen count, movement behavior, nutritional behavior, and are taken into account when generating the formulation and/or dosage. The method according to the invention hence reliably allows a secure generating of a formulation and/or dosage.

It is further proposed that the calibration and/or verification of the individually tuned formulation and/or dosage is effected following an electronic data transmission. Herein the individually tuned formulation and/or dosage can in particular be transmitted to third persons, e.g. a physician and/or a pharmacist, in particular via the communication unit of the device. Preferably after verification and/or validation of the transmitted formulation and/or dosage by third persons or by a software, a re-transmission is effected and the individually adapted dispensing unit and/or auxiliary operative substance unit can be accordingly dispensed and/or produced by means of the device. Thus it can advantageously be ensured that an innoxious formulation and/or dosage is generated.

The device according to the invention, the formulation and/or dosage generating unit according to the invention and/or the method according to the invention are/is herein not to be restricted to the application and implementation form described above. In particular, the device according to the invention, the formulation and/or dosage generating unit according to the invention and/or the method according to the invention can comprise, for implementing a functionality herein described, a number of individual elements, components and/or units that differs from the number herein mentioned.

### DRAWINGS

Further advantages result from the following description of the drawings. In the drawings seven exemplary embodiments of the invention are presented. The drawings, the description and the claims contain a plurality of features in combination. The person skilled in the art will purposefully also consider the features separately and will further combine them in an expedient manner.

It is shown in:

FIG. 1 a detail view of a device according to the invention in a schematic presentation,

FIG. 2 a detail view of an alternative device according to the invention embodied as an applicator device in a schematic presentation,

FIG. 3 a detail view of a further alternative device according to the invention embodied as a tin-like device in a schematic presentation,

FIG. 4 a detail view of a further alternative device according to the invention embodied as a capsule-like device in a schematic presentation,

FIG. 5 a detail view of a further alternative device according to the invention embodied as a tube-like device in a schematic presentation,

FIG. 6 a detail view of a further alternative device according to the invention embodied as a bottle-like device in a schematic presentation, and

FIG. 7 a detail view of a further alternative device according to the invention embodied as an automat device in a schematic view.

### DESCRIPTION OF THE EXEMPLARY EMBODIMENTS

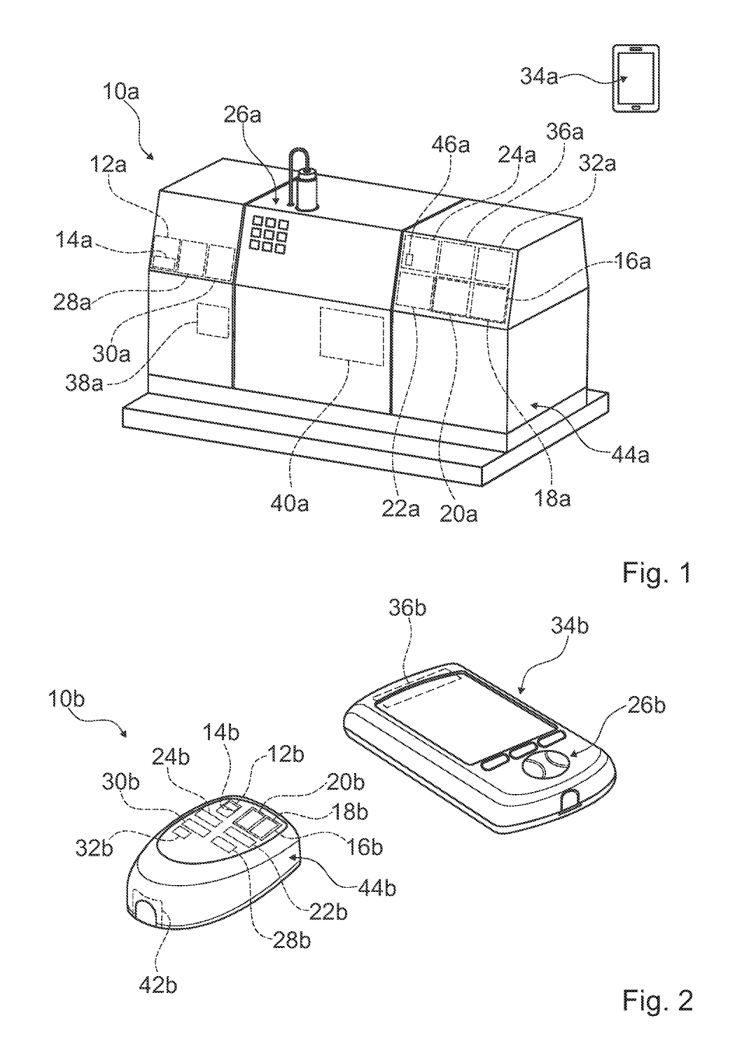

FIG. 1 shows a device 10a for a production of at least one individually adapted dispensing unit and/or auxiliary operative substance unit (not shown in detail here) and/or for a dispensing of at least one individually adapted dispensing unit (not shown in detail here) in dependence of at least one individual parameter. The device 10a is provided to produce at least one dispensing unit and/or auxiliary operative substance unit which is implemented as a powder, as a tablet, as a mash, as a liquid, as a cream or the like. Moreover the device 10a is provided, as an alternative or additionally, to dispense at least the dispensing unit produced by means of the device 10a to an individual, whose at least one individual parameter can be queried or captured. The device 10a is in the exemplary embodiment presented in FIG. 1 embodied as a 3D printer device. The dispensing unit and/or auxiliary operative substance unit is thus producible ready for use by means of the device 10a. It is however also conceivable that the device 10a has another implementation that is deemed expedient by a person skilled in the art.

Further the device 10a comprises at least one formulation and/or dosage generating unit 12a, which is provided to generate a formulation and/or a dosage of the dispensing unit and/or auxiliary operative substance unit in dependence of the at least one individual parameter. Herein the formulation and/or dosage generating unit 12a is provided to generate, according to a requirement depending on a status of an individual, an individually tuned formulation and/or dosage of the dispensing unit and/or auxiliary operative substance unit in dependence of the at least one individual parameter, in particular an individually tuned formulation and/or dosage of medication, nutrients, nutritional supplements, creams, cosmetics or the like. The formulation and/or dosage generating unit 12a is herein arranged at a housing unit 44a of the device 10a. Herein the housing unit 44a encloses the formulation and/or dosage generating unit 12a. The formulation and/or dosage generating unit 12a is hence arranged in the housing unit 44a. It is however also conceivable that the formulation and/or dosage generating unit 12a is detachably arrangeable at the housing unit 44a and, via a communication unit 32a of the device 10a, exchanges with and/or transmits to the device 10a electronic data for a generating of a formulation and/or dosage of the dispensing unit and/or auxiliary operative substance unit in dependence of the at least one individual parameter. The formulation and/or dosage generating unit 12a comprises at least one control and/or regulation unit 14a, which has at least one operating program that creates a formulation and/or dosage profile in dependence of an input of the at least one individual parameter. Herein, following an input, in particular a manual and/or automated input, of the at least one individual parameter, a formulation and/or dosage profile can be created and/or analyzed via the operating program of the control and/or regulation unit 14a. On this basis an individual formulation and/or dosage can be determined and/or outputted by means of the control and/or regulation unit 14a. By regular input of individual parameters, the formulation and/or dosage profile is adjustable to new conditions. Thus the formulation and/or dosage of the dispensing unit and/or auxiliary operative substance unit is accurately adjustable.

Furthermore the device 10a comprises at least one input unit 26a for a manual input of at least one individually tuned formulation and/or dosage for the production of the individually adapted dispensing unit and/or auxiliary operative substance unit. The input unit 26a is thus implemented as a manual-input unit. Herein the input unit 26a comprises at least one touch-sensitive display for a manual input of an individually tuned formulation and/or dosage, based on which the dispensing unit and/or auxiliary operative substance unit can be produced and/or dispensed by means of the device 10a. It is however also conceivable that the input unit 26a comprises, as an alternative or additionally, at least one operating element, e.g. a pushbutton, a switch, a selector switch, a keyboard or the like, by means of which a manual input of the at least one individual parameter can be effected.

The device 10a also comprises at least one evaluation unit 28a, which is provided to evaluate the at least one individually entered parameter at least regarding a generating of an individually tuned formulation and/or dosage. The evaluation unit 28a is herein provided to compare actual data with set data and to facilitate an individually tuned formulation and/or dosage on the basis of the at least one individually entered parameter.

The device 10s further comprises at least one sensor unit 30a, which is provided to identify the at least one individual parameter which is utilizable for a generating of an individually tuned formulation and/or dosage. To this purpose the sensor unit 30a comprises at least one sensor element (not shown here in detail), which is provided for determining the individual parameter. The sensor element can herein be embodied as a non-contact or as a contact-conditioned sensor element. Moreover, by means of the sensor unit 30a and the evaluation unit 28a acting together, a dosage and/or a dispensing of the dispensing unit and/or auxiliary operative substance unit is possible.

Furthermore the device 10a comprises at least one communication unit 32a, which is provided to exchange electronic data with at least one external unit 34a. The communication unit 32a is embodied as a wireless communication unit. It is however also conceivable that the communication unit 32a is implemented, as an alternative or additionally, as a wired communication unit. The external unit 34a can, for example, be embodied as a smartphone on which a software application is installed, by means of which an input and/or a capturing of the at least one individual parameter can be effected, which can be transmitted to the formulation and/or dosage generating unit 12a by means of the communication unit 32a. Thus a production of a dispensing unit and/or auxiliary operative substance unit and/or a dispensing of a dispensing unit produced by means of the device 10a can be controlled and/or regulated by means of the external unit 34a. It is further conceivable that by means of a communication of the device 10a and of the external unit 34a, a complete control and/or regulation of the device 10a can be effected.

The device 10a further comprises at least one environment parameter capturing unit 36a, which is provided to capture at least one environment parameter for a generating of an individually tuned formulation and/or dosage. To this purpose, the environment parameter capturing unit 36a comprises at least one environment parameter sensor element (not shown here in detail), which is provided to capture at least one environment parameter that can be taken into account in a generating of a formulation and/or dosage. Moreover, by the environment parameter capturing unit 36a and the evaluation unit 28a acting together, a dosage and/or a dispensing of the dispensing unit and/or auxiliary operative substance unit is possible. As an example, by means of the environment parameter sensor element a pollen count and/or allergens are/is capturable, which can be taken into account in a generating of a formulation and/or dosage by means of the formulation and/or dosage generating unit 12a, and/or in a dispensing of a dispensing unit.

Furthermore the device 10a comprises at least one formulation output unit 38a, which is provided to output at least one individually tuned formulation and/or dosage that has been generated by means of the formulation and/or dosage generating unit 12a. The formulation output unit 38a is herein provided to output the individually tuned formulation and/or dosage as a print-out. It is however also conceivable that the formulation output unit 38a is provided to output the individually tuned formulation and/or dosage in another way that is deemed expedient by a person skilled in the art, e.g. via an indication on a display, by a loudspeaker or the like.

The device 10a moreover comprises at least one supplies unit 16a for a stockage of at least one component for the production of the individually adapted dispensing unit and/or auxiliary operative substance unit. Herein the component for the production of the individually adapted dispensing unit and/or auxiliary operative substance unit can be implemented liquid, solid and/or gaseous. Thus the supplies unit 16a can be implemented as a liquid-matter supplies unit, as a solid-matter supplies unit and/or as a gaseous-matter supplies unit. The supplies unit 16a has at least two separate chambers 18a, 20a for a stockage of at least two different components of the individually adapted dispensing unit and/or auxiliary operative substance unit. Preferably the supplies unit 16a has a number, differing from two, of separate chambers 18a, 20a for a stockage of at least two different components of the individually adapted dispensing unit and/or auxiliary operative substance unit. The chambers 18a, 20a are herein embodied as stock containers. The stock containers can be exchangably arranged at the device 10a. Thus, in dependence of a composition of the desired dispensing unit and/or auxiliary operative substance unit, different stock containers with different components of the dispensing unit and/or auxiliary operative substance unit are arrangeable at the device 10a. The supplies unit 16a comprises to this purpose a number, differing from two, of stock container receiving elements (not shown here in detail).

The device 10a further comprises at least one dosage unit 22a for a dosage of at least one component of the individually adapted dispensing unit and/or auxiliary operative substance unit and/or for an output dosage of the individually adapted dispensing unit and/or auxiliary operative substance unit. The dosage unit 22a comprises to this purpose at least one dosage element (not shown here in detail), which is, as regards a dosage, connected to at least one of the chambers 18a, 20a. The dosage element is thus provided to control and/or to regulate an output out of one of the chambers 18a, 20a of at least one component for the production of the individually adapted dispensing unit and/or auxiliary operative substance unit. In total the dosage unit 22a comprises a plurality of dosage elements, which corresponds to a number of existing chambers 18a, 20a of the supplies unit 16a. Furthermore the dosage unit 22a comprises at least one output dosage element 46a, which is provided to dose an output quantity of the dispensing unit and/or auxiliary operative substance unit. The output dosage element 46a can herein be implemented as an output dosage valve. It is however also conceivable that the output dosage element 46a has a different implementation deemed expedient by a person skilled in the art, e.g. an implementation as an output dosage nozzle, as an output dosage slide or the like. The dosage unit 22a can be provided to effect a dosage of at least one component of the individually adapted dispensing unit and/or auxiliary operative substance unit and/or an output dosage of the dispensing unit and/or auxiliary operative substance unit in dependence of a weight of the respective components, of a weight of the stock container, of a number of component quantity units, of a flow rate measurement, of a valve control, of a changing of a cross section, of a time, of an optical component, of a measurement parameter, or the like.

The device 10a comprises at least one mixing unit 24a for a mixing of components of the individually adapted dispensing unit and/or auxiliary operative substance unit. The mixing unit 24a is herein connected to the dosage unit 22a by means of a component feed channel (not shown here in detail). The mixing unit 24a is embodied as an automated mixing unit, which is provided to automatedly mix the components of the dispensing unit and/or auxiliary operative substance unit, which have been dosed by the dosage unit 22a in dependence of the formulation and/or dosage generated by means of the formulation and/or dosage generating unit 12a. After a mixing of the components of the dispensing unit and/or auxiliary operative substance unit it is conceivable that the mixed components can be fed for finishing to a further unit of the device 10a, e.g. a pressuring unit, a heating unit, a cooling unit, or the like.

Further the device 10a comprises at least one packaging generating unit 40a, which is provided to produce a packaging of the individually adapted dispensing unit and/or auxiliary operative substance unit that has been produced by means of the device 10a. By means of the packaging generating unit 40a the dispensing unit and/or auxiliary operative substance unit can be packed directly after production. The packaging generating unit 40a can be additionally provided to produce an outer packaging of the individually adapted dispensing unit and/or auxiliary operative substance unit that has been produced by means of the device 10a.

A method for an operation of the device 10a has at least one method step, which comprises at least an individual generating of a formulation and/or dosage for a production of at least one individually adapted dispensing unit and/or auxiliary operative substance unit and/or for a dispensing of at least one individually adapted dispensing unit. To this purpose the at least one individual parameter can be entered via the input unit 26a and/or can be captured via the sensor unit 30a. The individual parameter is implemented e.g. as a pulse, as a blood pressure, as a heart rhythm, as a blood count, as a tooth state parameter, as a skin friendliness parameter, as a stress ECG parameter, as a lubricant viscosity, as a component glue type connection parameter, or the like. The generating of a formulation and/or dosage can thus be carried out by means of a manual input of the at least one individual parameter. As an alternative or additionally, a capturing of the at least one individual parameter for generating a formulation and/or dosage is effected in an at least partially automated manner. The formulation and/or dosage generating unit 12a herein generates a formulation and/or a dosage of the dispensing unit and/or auxiliary operative substance unit in dependence of the at least one individual parameter. Via the input unit 26a, via the sensor unit 30a and/or via the communication unit 32a, the generated formulation and/or a dosage of the dispensing unit and/or auxiliary operative substance unit can be validated, modified and/or supplemented by further information, e.g. blood values or the like. The production of the individually adapted dispensing unit and/or auxiliary operative substance unit and/or the dispensing of the individually adapted dispensing unit at least in dependence of the at least one individual parameter are/is effected in an at least partially automated manner. Herein an output of the produced dispensing unit and/or auxiliary operative substance unit is effected by means of the output dosage element of the dosage unit 22a.

It is herein conceivable that the individually adapted dispensing unit and/or auxiliary operative substance unit is producible by means of the device 10a together with an individual package insert and a corresponding packaging. It is however also conceivable that the formulation and/or dosage can be dispensed via an implant or another carrier agent deemed expedient by the person skilled in the art, e.g. by means of a patch or the like. The implant or another carrier agent deemed expedient by the person skilled in the art is implemented such that it is replenishable by an operator. It is moreover conceivable that the generated formulation and/or a dosage of the dispensing unit and/or auxiliary operative substance unit can be transmitted to a physician and/or to a pharmacy for a verification and/or for a production. Thus in at least one method step a calibration and/or a verification of the individually tuned formulation and/or dosage is effected. Herein the formulation and/or dosage can be transmitted to an external unit 34a of the physician and/or of the pharmacist via the communication unit 32a. The calibration and/or the verification of the individually tuned formulation and/or dosage is effected following an electronic data transmission. The production of at least one individually adapted dispensing unit and/or auxiliary operative substance unit and/or the dispensing of at least one individually adapted dispensing unit at least in dependence of the at least one individual parameter are/is effected by means of the device 10a in an at least partially automated manner.

In FIGS. 2 to 7 further exemplary embodiments of the invention are shown. The following descriptions and the drawings are substantially limited to the differences between the exemplary embodiments wherein, as regards structural elements having the same designation, in particular as regards structural elements having the same reference numerals, the drawings and/or the description of the other exemplary embodiments may principally also be referred to. For distinguishing the exemplary embodiments, the letter a is set after the reference numerals of the exemplary embodiment in FIG. 1. In the exemplary embodiments of FIGS. 2 to 7 the letter a is substituted by the letters b to f.

FIG. 2 shows an alternative device 10b for a production of at least one individually adapted dispensing unit and/or auxiliary operative substance unit and/or for a dispensing of at least one individually adapted dispensing unit in dependence of at least one individual parameter. Differing from the device 10a depicted in FIG. 1, the device 10b depicted in FIG. 2 is embodied as a mobile device that can be carried by an individual on his body. Herein the device 10b can be embodied as a patch, as a medication dispensing device, e.g. as an insulin pump device or the like. In case of an embodiment of the device 10b as a patch it is conceivable that the device is embodied as a nanotechnology device. It is herein conceivable that the device 10b embodied as a nanotechnology device is provided to feed dispensing units into a skin of a carrier of the device 10b via a thin heating layer, wherein a heat sensor element of the device prevents an overheating of the skin.

Moreover the device 10b depicted in FIG. 2 comprises, differing form the device 10a depicted in FIG. 1, at least one injection unit 42b for an injection of at least one individually adapted dispensing unit. To this purpose the injection unit 42b comprises at least one injection element (not shown here in detail), which is provided for an injection of the dispensing unit produced by means of the device 10b. The injection element is herein embodied as an injection needle. It is however also conceivable that the injection element has another implementation deemed expedient by a person skilled in the art. Furthermore an input unit 26b of the device 10b is a part of an external unit 34b. The external unit 34b is, for an electronic data exchange, connected to the device 10b via a communication unit 32b of the device 10b. An environment parameter capturing unit 36b of the device 10b can also be arranged in the external unit 34b and can exchange electronic data with the device 10b via the communication unit 32b. As regards further features and functions of the device 10b depicted in FIG. 2, the description of the device 10a depicted in FIG. 1 may be referred to.

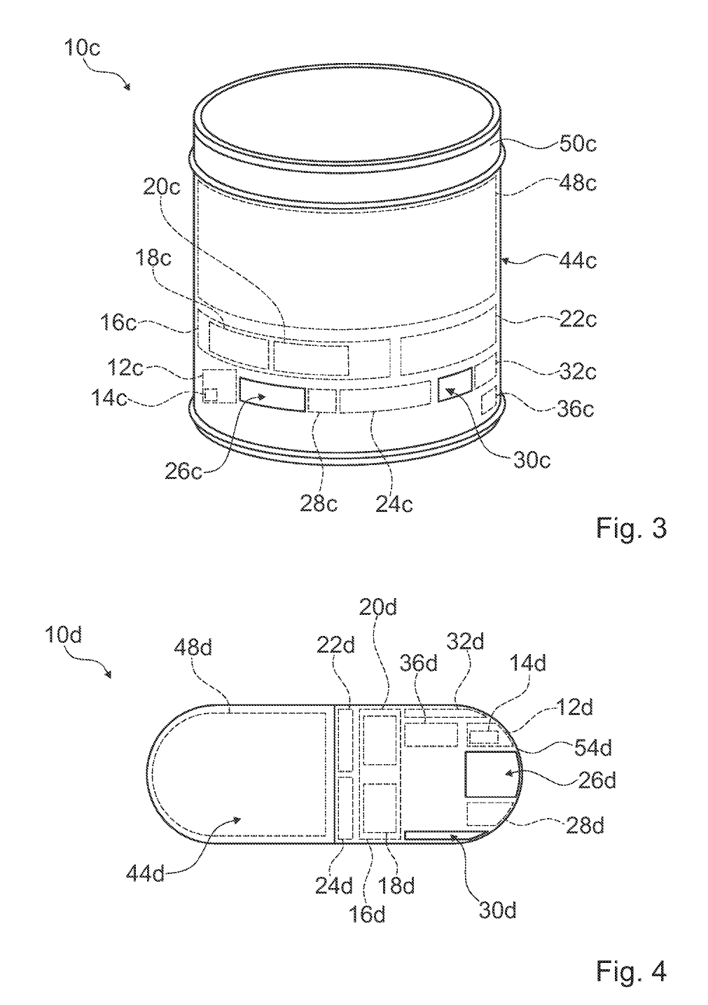

FIG. 3 shows a further, alternative device 10c for a production of an individually adapted dispensing unit and/or auxiliary operative substance unit and/or for a dispensing of at least one individually adapted dispensing unit in dependence on at least one individual parameter. Differing from the device 10a presented in FIG. 1, the device 10c shown in FIG. 3 is implemented tin-shaped. Herein the device 10c comprises a housing unit 44c implemented as a tin. The housing unit 44c is provided to receive and/or support further units (formulation and/or dosage generating unit 12c, supplies unit 16c, dosage unit 22c, mixing unit 24c, input unit 26c, evaluation unit 28c, sensor unit 30c, communication unit 32c and/or environment parameter capturing unit 36c) of the device 10c.

The device 10c comprises at least one supplies unit 16c for a stockage of at least one component for the production of the individually adapted dispensing unit and/or auxiliary operative substance unit. The supplies unit 16c comprises at least two separate chambers 18c, 20c for a stockage of at least two different components of the individually adapted dispensing unit and/or auxiliary operative substance unit. Further the device 10c comprises at least one dosage unit 22c for a dosage of at least one component of the individually adapted dispensing unit and/or auxiliary operative substance unit and/or for an output dosage of the individually adapted dispensing unit and/or auxiliary operative substance unit. Moreover the device 10c comprises at least one mixing unit 24c for a mixing of components of the individually adapted dispensing unit and/or auxiliary operative substance unit. The supplies unit 16c, the dosage unit 22c and the mixing unit 24c are preferably arranged in a bottom-near region of the housing unit 44c. The housing unit 44c also comprises at least one receiving chamber 48c, which is provided for receiving a produced dispensing unit and/or auxiliary operative substance unit. The receiving chamber 48c can be filled by means of an output dosage element (not shown here in detail) of the dosage unit 22c. Moreover the housing unit 44c comprises a closure element 50c for a closure of the receiving chamber 48c. An operator of the device 10c can take the produced dispensing unit and/or auxiliary operative substance unit from the receiving chamber 48c for a dispensing. Herein the dispensing unit and/or auxiliary operative substance unit can be implemented as a tablet, as a liquid, as a paste, as a cream, as a powder, or the like. Regarding further features and functions of the device 10c shown in FIG. 3, the description of the device 10a shown in FIG. 1 may be referred to.

FIG. 4 shows a further, alternative device 10d for a production of at least one individually adapted dispensing unit and/or auxiliary operative substance unit and/or for a dispensing of at least one individually adapted dispensing unit in dependence on at least one individual parameter. Differing from the device 10a presented in FIG. 1, the device 10d shown in FIG. 4 is implemented capsule-shaped. Herein the device 10d comprises a housing unit 44d that is implemented as a capsule. The housing unit 44d is provided to receive and/or support further units (formulation and/or dosage generating unit 12d, supplies unit 16d, dosage unit 22d, mixing unit 24d, input unit 26f, evaluation unit 28d, sensor unit 30d, communication unit 32d and/or environment parameter capturing unit 36d) of the device 10d.

The device 10d comprises at least one supplies unit 16d for a stockage of at least one component for the production of the individually adapted dispensing unit and/or auxiliary operative substance unit. The supplies unit 16d comprises at least two separate chambers 18d, 20d for a stockage of at least two different components of the individually adapted dispensing units and/or auxiliary operative substance units. Furthermore the device 10d comprises at least one dosage unit 22d for a dosage of at least one component of the individually adapted dispensing unit and/or auxiliary operative substance unit and/or for an output dosage of the individually adapted dispensing unit and/or auxiliary operative substance unit. The device 10d moreover comprises at least one mixing unit 24d for a mixing of components of the individually adapted dispensing unit and/or auxiliary operative substance unit. The housing unit 44d further comprises at least one receiving chamber 48d, which is provided for receiving a produced dispensing unit and/or auxiliary operative substance unit. The receiving chamber 48d can be filled by means of an output dosage element (not shown here in detail) of the dosage unit 22d. The receiving chamber 48d can be closed off by a closure element 50d of the housing unit 44d after filling. The receiving chamber 48d is furthermore arranged at a base body 54d of the housing unit 44d such that it can be taken off. The receiving chamber 48d is herein made of an easily digestible material. Thus the filled receiving chamber 48d, in particular after being filled with a dispensing unit and/or auxiliary operative substance unit, can be dispensed orally. It is however also conceivable that the receiving chamber 48d has another implementation deemed expedient by a person skilled in the art and can be dispensed in another way. The receiving chamber 48d is thus implemented to be exchangeable and/or for single-use. Regarding further features and functions of the device 10d shown in FIG. 4, the description of the device 10a shown in FIG. 1 may be referred to.

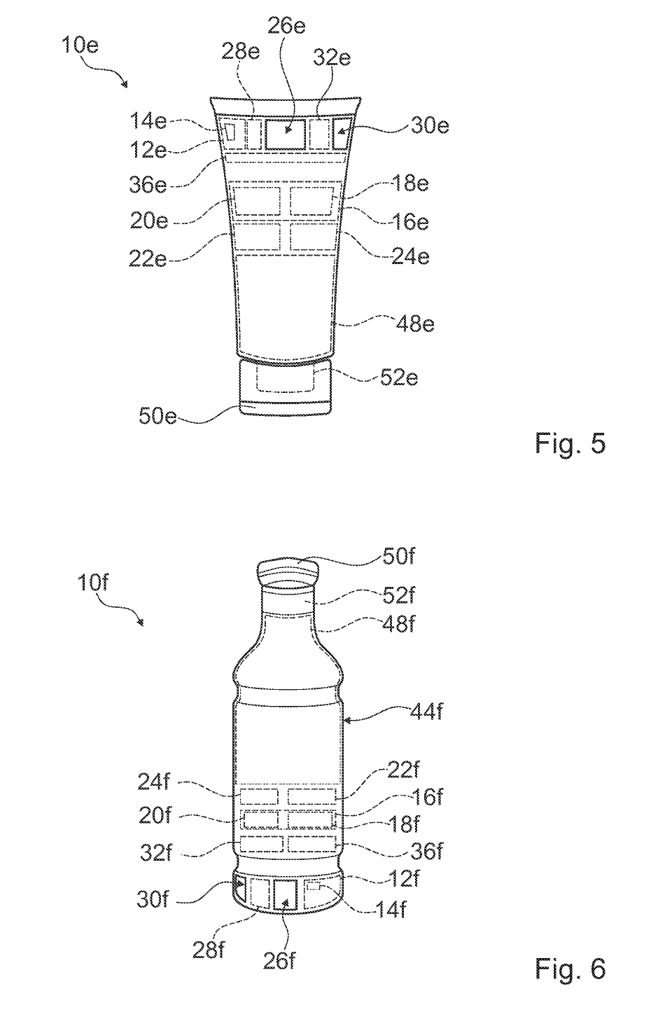

FIG. 5 shows another, alternative device 10e for a production of at least one individually adapted dispensing unit and/or auxiliary operative substance unit and/or for a dispensing of at least one individually adapted dispensing unit in dependence on at least one individual parameter. Differing from the device 10a shown in FIG. 1, the device 10e shown in FIG. 5 is implemented tube-shaped. Herein the device 10e comprises a housing unit 44e implemented as a tube. The housing unit 44e is provided to receive and/or support further units (formulation and/or dosage generating unit 12e, supplies unit 16e, dosage unit 22e, mixing unit 24e, input unit 26e, evaluation unit 28e, sensor unit 30e, communication unit 32e and/or environment parameter capturing unit 36e) of the device 10e.

The device 10e comprises at least one supplies unit 16e for a stockage of at least one component for the production of the individually adapted dispensing unit and/or auxiliary operative substance unit. The supplies unit 16e comprises at least two separate chambers 18e, 20e for a dosage of at least one component of the individually adapted dispensing unit and/or auxiliary operative substance unit. The supplies unit 16e comprises at least two separate chambers 18e, 20e for a stockage of at least two different components of the individually adapted dispensing unit and/or auxiliary operative substance unit. The device 10e further comprises at least one dosage unit 22e for a dosage of at least one component of the individually adapted dispensing unit and/or auxiliary operative substance unit and/or for an output dosage of the individually adapted dispensing unit and/or auxiliary operative substance unit. Moreover the device 10e comprises at least one mixing unit 24e for a mixing of components of the individually adapted dispensing unit and/or auxiliary operative substance unit. Furthermore the housing unit 44e comprises at least one receiving chamber 48e, which is provided for receiving a produced dispensing unit and/or auxiliary operative substance unit. The receiving chamber 48e is herein arranged between an output dosage element 52e and the supplies unit 16e of the dosage unit 22e. Thus the output dosage element 52e is provided to output, in dependence of a dosage generated by means of a formulation and/or dosage generating unit 12e of the device 10e, the dispensing unit and/or auxiliary operative substance unit that is arrangeable in the receiving chamber 48e. It is however also conceivable that the output dosage element 52e is directly connected to the mixing unit 24e for outputting the dispensing unit and/or auxiliary operative substance unit directly after production. Moreover it is also conceivable that the device 10e can be loaded with exchangeable dispensing unit cartridges, and merely a quantity can be outputted in dependence of a dosage generated by means of a formulation and/or dosage generating unit 12e of the device 10e. Regarding further features and functions of the device 10e shown in FIG. 5, the description of the device 10a shown in FIG. 1 may be referred to.

FIG. 6 shows another, alternative device 10f for a production of at least one individually adapted dispensing unit and/or auxiliary operative substance unit and for a dispensing of at least one individually adapted dispensing unit in dependence on at least one individual parameter. Differing from the device 10a presented in FIG. 1, the device 10f shown in FIG. 6 is embodied bottle-shaped. Herein the device 10f comprises a housing unit 44f implemented as a bottle. The housing unit 44f is provided to receive and/or support further units (formulation and/or dosage generating unit 12f, supplies unit 16f, dosage unit 22f, mixing unit 24f, input unit 26f, evaluation unit 28f, sensor unit 30f, communication unit 32f and/or environment parameter capturing unit 36f) of the device 10f.

The device 10f comprises at least one supplies unit 16f for a stockage of at least one component for the production of the individually adapted dispensing unit and/or auxiliary operative substance unit. The supplies unit 16f comprises at least two separate chambers 18f, 20f for a stockage of at least two different components of the individually adapted dispensing unit and/or auxiliary operative substance unit. Further the device 10f comprises at least one dosage unit 22f for a dosage of at least one component of the individually adapted dispensing unit and/or auxiliary operative substance unit and/or for an output dosage of the individually adapted dispensing unit and/or auxiliary operative substance unit. Moreover the device 10f comprises at least one mixing unit 24f for a mixing of components of the individually adapted dispensing unit and/or auxiliary operative substance unit. The supplies unit 16f, the dosage unit 22f and the mixing unit 24f are preferably arranged in a bottom-near region of the housing unit 44f that is implemented as a bottle. Moreover the housing unit 44f comprises at least one receiving chamber 48f, which is provided for receiving a produced dispensing unit and/or auxiliary operative substance unit. The receiving chamber 48f can be filled by means of an output dosage element (not shown here in detail) of the dosage unit 22f. The housing unit 44f further comprises a closure element 50f for a closure of the receiving chamber 48f. An operator of the device can take the produced dispensing unit and/or auxiliary operative substance unit from the receiving chamber 48f for a dispensing. Herein the dispensing unit and/or auxiliary operative substance unit is embodied as a liquid, e.g. as a nutritional supplement or the like. Regarding further features and functions of the device 10f shown in FIG. 6, the description of the device 10a shown in FIG. 1 may be referred to.

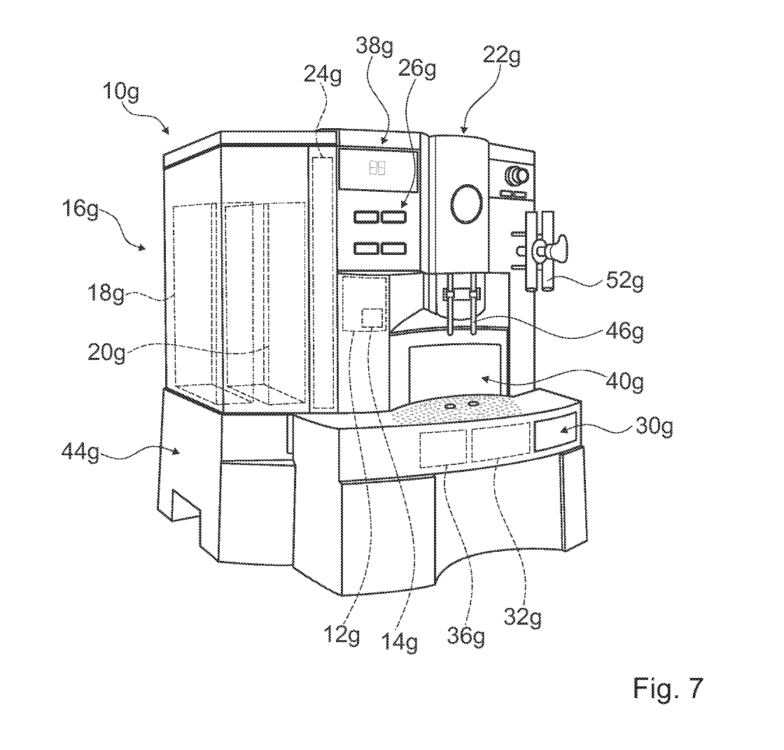

FIG. 7 shows a further, alternative device 10g for a production of at least one individually adapted dispensing unit and/or auxiliary operative substance unit and/or for a dispensing of at least one individually adapted dispensing unit in dependence on at least one individual parameter. Differing from the device 10a presented in FIG. 1, the device 10g shown in FIG. 7 is provided to produce a dispensing unit and/or auxiliary operative substance unit implemented as a liquid and/or mash and/or to dispense a dispensing unit implemented as a liquid. Herein the device 10g comprises a housing unit 44g that is implemented like a drinks machine. The housing unit 44g is provided to receive and/or support further units (formulation and/or dosage generating unit 12g, supplies unit 16g, dosage unit 22g, mixing unit 24g, input unit 26g, evaluation unit 28g, sensor unit 30g, communication unit 32g and/or environment parameter capturing unit 36g) of the device 10g. Regarding further features and functions of the device 10g shown in FIG. 7, the description of the device 10a shown in FIG. 1 may be referred to.

1. A device for a production of at least one individually adapted dispensing unit and/or auxiliary operative substance unit and/or for a dispensing of at least one individually adapted dispensing unit in dependence on at least one individual parameter.

2. The device according to claim 1, comprising
at least one formulation and/or dosage generating unit, which is provided to generate a formulation and/or a dosage in dependence on the at least one individual parameter.

3. The device according to claim 2, wherein
the formulation and/or dosage generating unit comprises at least one control and/or regulation unit, which comprises at least one operating program that creates a formulation and/or dosage profile in dependence on an input of the at least one individual parameter.

4. The device according to claim 1, comprising
at least one supplies unit for a stockage of at least one component for the production of the individually adapted dispensing unit and/or auxiliary operative substance unit.

5. The device according to claim 4, wherein
the supplies unit comprises at least two separate chambers for a stockage of at least two different components of the individually adapted dispensing units and/or auxiliary operative substance units.

6. The device according to claim 1, comprising
at least one dosage unit, which is provided for a dosage of at least one component of the individually adapted dispensing unit and/or auxiliary operative substance unit and/or for an output dosage of the individually adapted dispensing unit and/or auxiliary operative substance unit.

7. The device according to claim 1, comprising
at least one mixing unit, which is provided for mixing components of the individually adapted dispensing unit and/or auxiliary operative substance unit.

8. The device according to claim 1, comprising
at least one input unit, which is provided for a manual input of at least one individually tuned formulation and/or dosage for the production of the individually adapted dispensing unit and/or auxiliary operative substance unit.

9. The device according to claim 1, comprising
at least one evaluation unit, which is provided to evaluate the at least one individually entered parameter at least regarding a generating of an individually tuned formulation and/or dosage.

10. The device according to claim 1, comprising
at least one sensor unit, which is provided to determine the at least one individual parameter that can be used for a generating of an individually tuned formulation and/or dosage.

11. The device according to claim 1, comprising
at least one communication unit, which is provided to exchange electronic data with at least one external unit.

12. The device according to claim 1, comprising
at least one environment parameter capturing unit, which is provided to capture at least one environment parameter for a generating of an individually tuned formulation and/or dosage.

13. The device according to claim 1, comprising
at least one formulation output unit, which is provided to output at least one individually tuned formulation and/or dosage.

14. The device according to claim 1, comprising
at least one packaging generating unit, which is provided to produce a packaging of the individually adapted dispensing unit and/or auxiliary operative substance unit.

15. The device according to claim 1, comprising
at least one injection unit, which is provided for an injection of at least one individually adapted dispensing unit.

16. A formulation and/or dosage generating unit of a device according to claim 1.

17. A method for operating the device according to claim 1, wherein
an individual generating of a formulation and/or dosage is provided for a production of an individually adapted dispensing unit and/or auxiliary operative substance unit and/or for a dispensing of an individually adapted dispensing unit.

18. The method according to claim 17, wherein the generating of a formulation and/or dosage can be carried out by means of a manual input of the at least one individual parameter.

19. The method according to claim 17, wherein a capturing of the at least one individual parameter for generating a formulation and/or dosage is effected in an at least partially automated manner.

20. The method according to claim 17, wherein
the production of the individually adapted dispensing unit and/or auxiliary operative substance unit and/or the dispensing of the individually adapted dispensing unit are/is effected at least in dependence on the at least one individually adapted parameter in an at least partially automated manner.

21. The method according to claim 17, wherein
at least one method step a calibration and/or a verification of the individually tuned formulation and/or dosage is effected.

22. The method according to claim 21, wherein the calibration and/or the verification of the individually tuned formulation and/or dosage is effected following an electronic data transmission.
